(19) United States
(12) Patent Application Publication
(10) Pub. No.: US 2010/0171083 A1
(43) Pub. Date: Jul. 8, 2010

(54) TIE ROD AND BALL JOINT SEPARATOR

(75) Inventors: Jerry A. Vaught, Buck Creek, IN (US); Scotty R. Kurtz, Clarinda, IA (US)

Correspondence Address: BANNER & WITCOFF, LTD., TEN SOUTH WACKER DRIVE, SUITE 3000, CHICAGO, IL, 60606, US

(73) Assignee: Lisle Corporation, Clarinda, IA (US)

(21) Appl. No.: 12/349,089

(22) Filed: Jan. 6, 2009

(51) Int. Cl. B66F 11/00

(52) U.S. Cl. 254/21

(57) ABSTRACT

An automotive tool for separating ball joint connections, tie rods from steering arms, and other similar procedures has a wedge shaped head, with a pair of projecting prongs, and a handle. The head and handle are integral or removably secured together by a threaded connection so that different sized heads may be used either with a handle designed to be struck by a hand held hammer or an air hammer. Each prong of the wedge shaped head includes a longitudinally extending array of multiple, reverse taper steps or flats that facilitate engagement of the tool with the parts being separated.

### BACKGROUND OF THE INVENTION

The present invention relates to an improved automotive tool generally of the type disclosed in U.S. Pat. No. 4,926,537 issued May 22, 1990 entitled “Tie Rod and Ball Joint Separator”. U.S. Pat. No. 4,926,537 is incorporated herein by reference. Such tools are used to separate ball joint connections and tie rod ends from steering arms by way of example.

Separating tools are well known in the automobile repair art and may include a generally wedge shaped head supported on an impact handle. The wedge shaped head typically includes a pair of spaced apart, tapered prongs that are shaped to fit between the parts to be separated. The prongs are thus fitted between the parts and the handle is impacted to drive the wedge shaped prongs and separate the parts.

It has long been the practice in the art to make different sizes of automotive separating tools for different jobs and parts. The principal difference between different sizes relates to the dimensions of the wedge shaped head including the spacing between and dimensions of the prongs of the wedge shaped head. The length and overall size of the impact handles may also be changed proportionally as the dimensions of the wedge shaped head are changed. It has also been recognized that a well equipped automotive repair shop or garage should have at least three differently sized tools. Further, the type of the impact handle may be varied for driving with a hand held hammer or an air hammer.

A connection between various types of impact handles and sizes of heads is taught in U.S. Pat. No. 4,926,537. The connection enables ready separation of a wedge shaped head of a chosen size from a chosen type of drive or impact handle so that the same handle may be used with different sized heads. Thus, a handle designed for a manual striking hammer or a handle designed for an air hammer may be used with the same head. Hence, a well equipped automotive repair shop or garage need only purchase two handles, one designed to be struck by a hand held hammer and the other designed for use with an air hammer, and three different size heads to provide the tools generally required for its business. This is in contrast to the previous purchase requirement of six different tools.

Nonetheless, regardless of the use of a unitary single piece tool or a two piece separate handle and head tool, the wedge shaped heads known in the field can exhibit a tendency to disengage from between parts that are being separated as a result of recoil of the wedge shaped head as it is driven into contact with parts that are to be separated. That is, the tapered surfaces of the prongs may not remain properly wedged between parts that are being separated. As a consequence, the head of the tool may require constant reinsertion between the parts being separated. Thus, an object of the invention is to address the observed problem.

### SUMMARY OF THE INVENTION

In a principal aspect, the present invention comprises an automotive tool for separating ball joint connections, tie rods from steering arms and other parts. The tool includes a fork having first and second, wedge shaped or tapered, bifurcated, spaced, generally parallel prongs connected to an impact handle. The wedge shaped prongs have a leading end with a forward end, generally planar, top side surface and a forward end, generally planar bottom side surface forming a diverging, generally acute angle therebetween. The forward end top side and bottom side surfaces of the leading end join respectively to generally planar, diverging main surfaces with at least one of the main top side and bottom side surfaces of at least one of the prongs including multiple, reverse taper steps or lands. The opposite lateral sides of each prong are generally transverse to the tapered or diverging surfaces that define the wedge shapes and are generally parallel to each other. The leading end of each prong typically is comprised of a flat planar forward end top side surface and a flat planar forward end bottom side surface, said forward end top side and bottom side surfaces intersecting at an acute angle greater than the acute angle of the main side surfaces defining each prong. The main top or first side surfaces of the prongs are generally coplanar as are the main bottom or second side surfaces. However, at least one of the main side surfaces includes the reverse taper or saw tooth steps or lands. Similarly, the extreme outer end of each prongs are formed by forward end bottom and top side surfaces that are coplanar. Alternative aspects of the prong design include variation of the number of reverse taper steps, inclusion of the reverse taper steps on both the main top side surface and main bottom side surface of one or two prongs forming the fork configuration, variation of the length, number and angle of the reverse taper steps, and variation of the length and taper of the individual prongs and/or the leading end thereof.

Thus, it is an object or characterization of the tool of the invention to provide an automotive tool comprised of an impact head, with one or more wedge shaped prongs having reverse taper steps constructed for separation of components or parts such as ball joints.

Another object of the invention is to provide an automotive tool kit comprised of multiple sized wedge shaped prongs that may be combined with various types of drive handles and wherein the prongs include at least one tapered surface which includes one or more reverse taper steps.

Another object of the invention is to provide an automotive separating tool having multiple wedge shaped prongs at least one of which includes one or more reverse taper steps.

Another object of the invention is to provide an inexpensive, rugged and easily usable automotive part separation tool.

These and other objects, advantages, features benefits and characterizations of the invention are set forth in the detailed description which follows.

### BRIEF DESCRIPTION OF THE DRAWING

In the detailed description which follows, reference will be made to the drawing comprised of the following figures:

FIG. 1 is an isometric view of a prior art tool which incorporates various drive handles in combination with various wedge shaped head members;

FIG. 2 is a partial cross sectional view of a prior art impact handle joined to a wedge shaped head member;

FIG. 3 is a partial cross sectional view of a prior art air hammer impact handle joined to a wedge shaped head member;

FIG. 4 is a bottom plan view of a first embodiment of a wedge shaped head of the invention;

FIG. 5 is a top plan view of the wedge shaped head depicted in FIG. 4;

FIG. 6 is a cross sectional view of the head depicted in FIG. 5 taken along the line 6-6;

FIG. 6A is an enlarged side view of reverse taper surfaces in FIG. 6;

FIG. 7 is a bottom plan view of a second embodiment of a wedge shaped head of the invention;

FIG. 8 is a top plan view of the embodiment of FIG. 7;

FIG. 9 is a cross sectional view of the embodiment depicted in FIG. 8 taken along the line 9-9;

FIG. 9A is an enlarged side view of reverse taper surfaces in FIG. 9;

FIG. 10 is a bottom plan view of a third embodiment of a wedge shaped head of the invention;

FIG. 11 is a top plan view of the wedge shaped head of FIG. 10;

FIG. 12 is a cross sectional view of the wedge shaped head of FIG. 11 taken along the line 12-12;

FIG. 12A is an enlarged side view of reverse taper surfaces in FIG. 12;

FIG. 13 is a plan view of an air hammer driven handle;

FIG. 14 is a plan view of a hand hammer driven handle;

FIG. 15 is an isometric view illustrating use of an embodiment of the tool of the invention; and

FIG. 16 is an isometric view of an alternative embodiment of the invention wherein a wedge shaped head and handle are made as an integral unit.

### DESCRIPTION OF EMBODIMENTS OF THE INVENTION

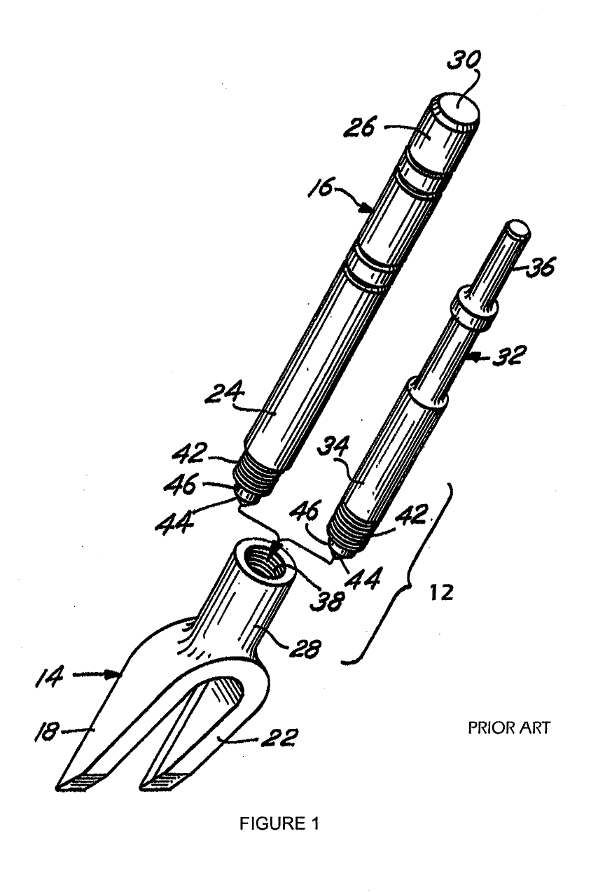

FIGS. 1, 2 and 3 illustrate a prior art construction as disclosed in U.S. Pat. No. 4,926,537. Referring to FIG. 1 of the drawing, an automotive separating tool kit is shown generally at 12. This tool includes a tapered, wedge shaped head 14 and a separate elongated generally cylindrical handle 16 and an optional, separate air hammer handle 32.

One side or end of the head 14 has a pair of integral, projecting prongs 18 and 22 formed thereon so as to define a generally “U” shaped fork. Prongs 18, 22 are of conventional design and shape, are tapered toward their free, distal ends, and are spaced apart a preselected distance. Prongs 18 and 22 are adapted to be disposed between parts to be separated so that when force is applied to the attached handle 16, the head 14 will force the parts apart.

In the past, it has generally been the practice to separate the prongs 18 and 22 a particular distance. For example, the prongs 18 and 22 may be separated a distance of 1⅛ inches, or 15/16 inches, or some other selected distance. Typically, prongs 18, 20 are parallel, but they may diverge or converge slightly.

The handle 16 has a first end 24 which may be threaded into and secured to the tapered wedge shaped head 14 at a distal end 28 of head 14. More specifically, the end 24 of the handle 16 is threaded into a threaded socket 38 located in the end 28 of the head 14, that is, to the side or end 28 opposite from the side or end from which the prongs 18 and 22 project. The driving or distal end 26 of the handle 16, as well as the entire handle 16, is designed so that the handle 16 may be repeatedly struck by a hand held hammer being used by a mechanic or workman. In this regard, the end 26 of handle 16 includes a flat surface 30 to receive hammer blows. The surface 30 is substantially perpendicular to the longitudinal axis of the handle 16.

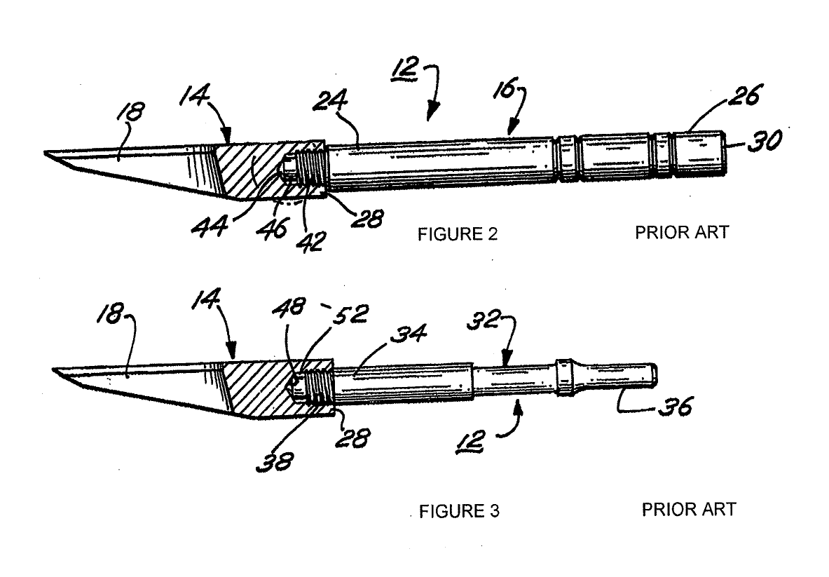

As illustrated in FIG. 3, the tool 12 is also adapted to be used with another style of handle 32 that is designed and shaped to be driven by an air hammer. Like the handle 16, the handle 32 includes a first end 34 and a distal end 36. The first ends 24 and 34 of the handles 16 and 32, respectively, are structurally and functionally substantially identical. The opposite or distal end 36 of the handle 32, as noted above, is designed for cooperation with an air hammer. Because the head 14 of the tool shown in FIG. 3 is structurally and functionally substantially identical to the head 14 of the tool shown in FIGS. 1 and 2, the same reference numbers have been used to indicate the same parts.

With reference to FIG. 3, the side or end 28 of the head 14 has the generally centrally located socket or recess 38 formed therein. Recess 38 is internally threaded. Its central longitudinal axis is coaxial with the longitudinal axis of the head 14 and also with the central longitudinal axis of either handle 16, 32 when either handle 16, 32 is disposed within the recess 38.

The first ends 24 and 34 of the handles 16 and 32, respectively, are adapted to be received within the recess 38. Each of the ends 24 and 34 of these handles includes an identical threaded section 42 that has a reduced diameter, as compared to the dimensions of the adjacent portion of the handle 16, 32. For this reason, only one such section 42 is described. The pilot end 44 of the section 42 is conical and tapered to a point 45. An unthreaded land 46 separates the tapered pilot end 44 from the threads on the section 42.

The threads formed in the recess 38 do not extend to the bottom of the recess 38. Rather, there is a short space 52 defined by a cylindrical surface between the bottom of the recess 38 and the innermost ends of the threads formed in the recess 38. The bottom of the recess 38 is tapered, as at 48, with the angle of taper being substantially identical to the angle of taper on the pilot end 44 of the projection 42.

The lengths of the threads in the threaded recess 38 and on the threaded projection 42 are selected so that when a handle 16 is threaded into the recess 38, the pilot end 44 will bottom out or abut the tapered bottom 48 of the recess 38. This bottoming out or abutment reduces the stress on the threads when the handle 16, 32 is struck by a hammer or is driven by an air hammer. In practice, the pilot end 44 has a frustoconical or conical shape and the tapered bottom 48 of the counterbore or recess 38 has a compatible conical shape thereby accommodating any slight dimensional discrepancies of the pilot end 44.

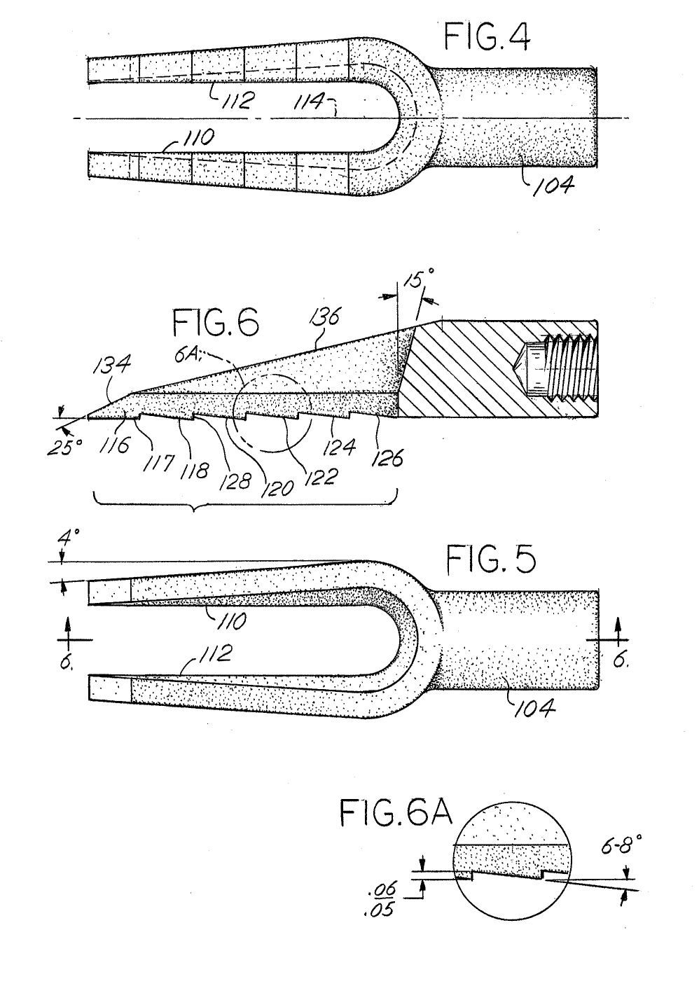

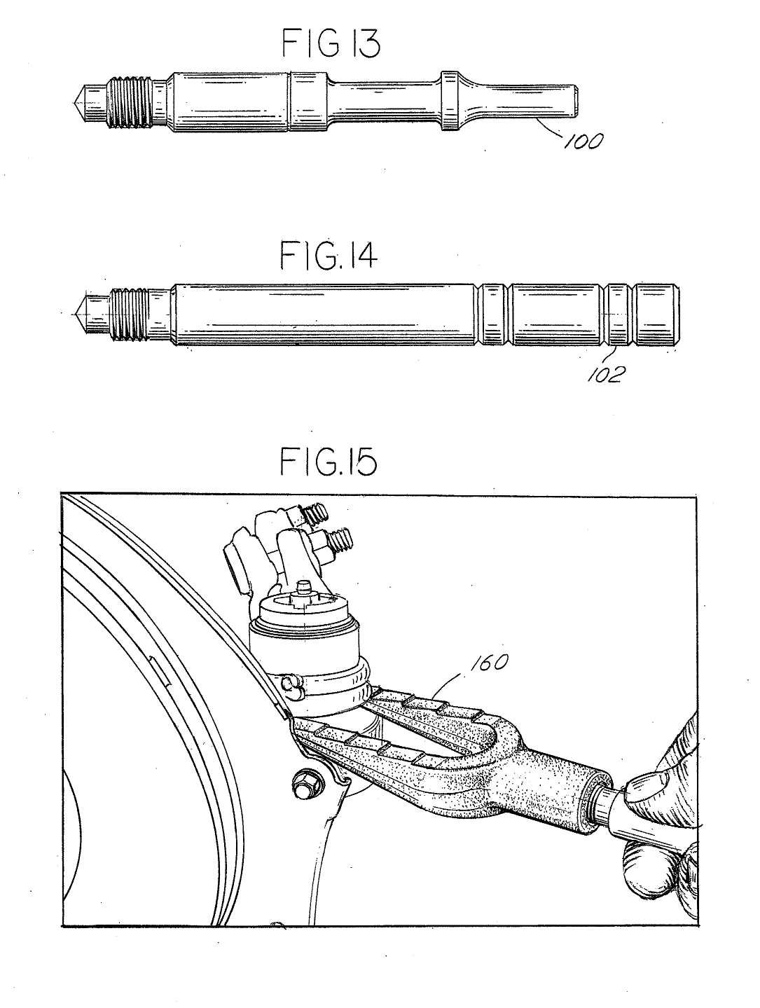

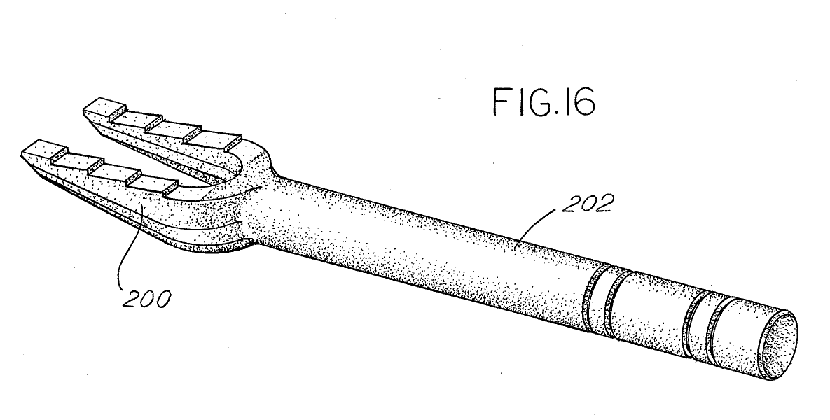

FIGS. 4-15 illustrate features of various embodiments of the invention. FIGS. 13 and 14 depict drivers 100, 102, or handles 100 and 102, which have substantially the construction described with respect to handles 32, 16, respectively, in FIGS. 1-3. The handles 100, 102 are designed to co-act with, or cooperate with, the various types of head constructions 104, 106 and 108 depicted, respectively, in FIGS. 4-12. Thus, the previously described relationship and arrangement for the threaded connection between the handles 16 and 32 and wedge shaped heads having prongs thereon, as depicted in FIGS. 4-12, is substantially the same as described with respect to FIGS. 1-3. However, the design of the wedge shaped heads 104, 106, 108 in FIGS. 4-12 is significantly distinct to enhance the utility of the tool. It is also to be noted that a kit of multiple wedge shaped heads as depicted in FIGS. 4-12, by way of example, and multiple drivers 100, 102 such as depicted in FIGS. 13 and 14 may be provided.

TABLE I

| DIMENSION | A | B | C | D | E | F | G | H | I |
|---|---|---|---|---|---|---|---|---|---|
| Size 11/16 | 0.687 ± 0.012 | 5 | 25° ± 1 | 13° ± 1 | 6°-8° | 2.625 ± 0.012 | 0.49-0.51 | 0.047-.0055 | 0.05-0.06 |
| Size 15/16 | 0.937 ± 0.012 | 4 | 25° ± 1 | 13° ± 1 | 4°-6° | 2.500 ± 0.012 | 0.61-0.63 | 0.047-0.055 | 0.05-0.06 |
| Size 1⅛ | 1.113-1.137 | 3 | 27°-29° | 12°-14° | 4°-6° | 2.262-2.238 | 0.74-0.76 | 0.047-0.055 | 0.05-0.06 |

Referring to the construction of the heads, however, reference is directed to Table I and a first embodiment depicted in FIGS. 4-6A. From a commercial viewpoint, the embodiment depicted in FIGS. 4-6A is identified as 11/16 inch size. In this regard, the spacing of the opposed inside surfaces of prongs 110 and 112 is approximately 11/16 inch. This spacing, of course, is associated with a desire to enable the prongs 110, 112 to be inserted around some type of connecting member for elements which need to be separated such as a ball joint. The choice of the size of a head is dependent upon spacing of the prongs and typically becomes a decision made by a mechanic utilizing the tools and selecting components from a tool kit of the described elements.

Referring therefore to FIGS. 4-6A, the wedge shaped head 104 includes a first prong 110 and a second generally parallel prong 112 which each extend longitudinally in an axial direction defined by axis 114. The prongs 110, 112 are spaced as described and include a wedge configured leading end 116 and a series of five reverse taper lands or flats 118, 120, 122, 124 and 126 along a bottom side surface 125. The flats 118, 120, 122, and 124, in combination with the wedge leading end 116 define, in a profile view, a saw tooth arrangement as depicted in FIG. 6. Each of the flats 118, 120, 122, 124, 126 is separated from the other by a transverse surface, such as surface 128, separating flats 118 and 120. The intersection of transverse surface 128 with a flat (e.g. flat 118) defines an edge which is parallel to a first, top side main surface 136 and the surface segments forming second main bottom side surface 125. The transverse surface 128 has a height dimension I in Table I. The length of flat 118 has a dimension G in Table I. The prongs 110 and 112 have a length dimension F in FIG. 4. The reverse taper surface such as the flat or surface 118 has a reverse taper as depicted in FIG. 6A at an angle identified in the range of item E of Table 1. The face 134 of leading end of prongs 110, 112 forms an angle with the horizontal or longitudinal axis represented by the entry D in Table I. Face 134 of leading end 116 forms an angle with opposite side surface 117 in the range of 20°-30°, typically 25°±1° (see Table I, entry E). In general, therefore, a bottom or second side main surface 125 of each prong 110, 112 forms an acute angle with a first main top side surface 136, and the first and second side surface 136, 125 are coplanar and form identically shaped prongs 110, 112.

The lateral spacing of the prongs 110 and 112 is set forth as item A in Table I. The length of the legs or prongs is set forth as item F in Table I. The length of each step or flat in the longitudinal direction is set forth in Table I as item G with respect to the embodiment of FIGS. 4-6A. The flat front end of the prong 126 has a height dimension in the range of item H in Table I for the embodiment of FIGS. 4-6A.

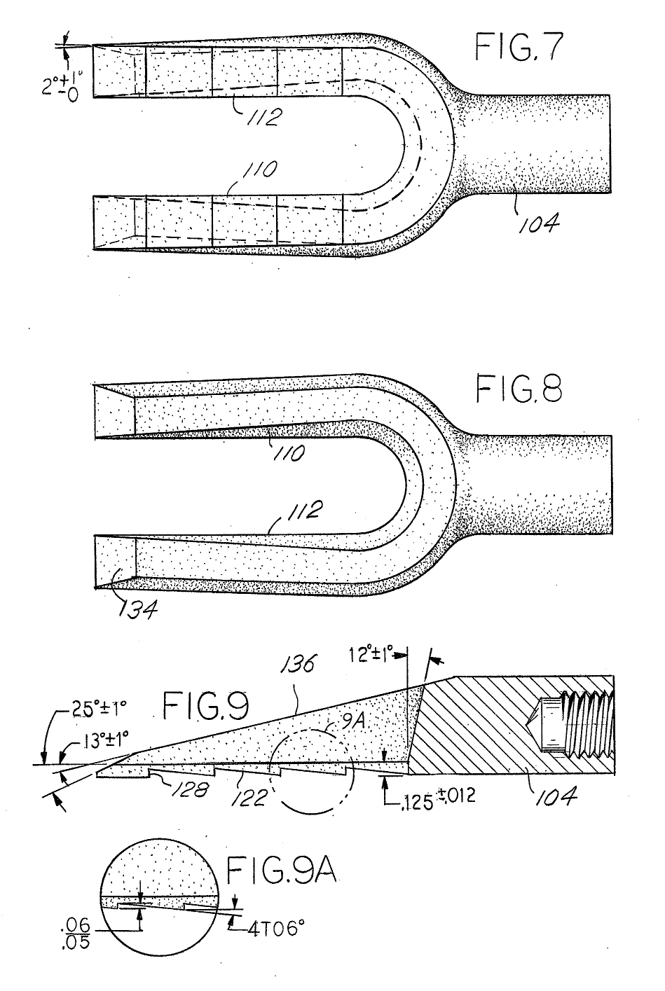

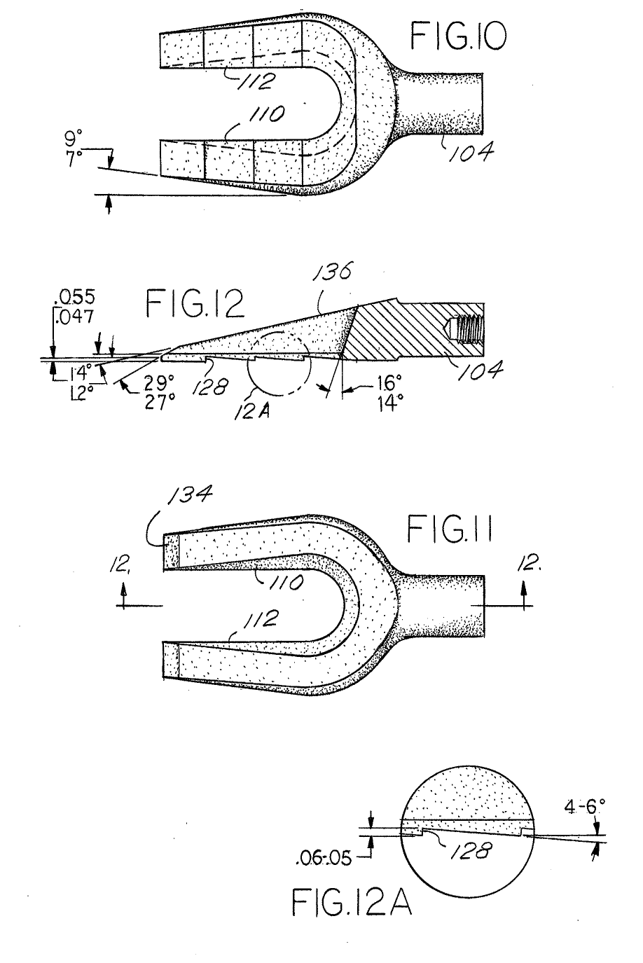

Similarly, the dimensions and features of corresponding component parts of the embodiment of FIGS. 7-9A are set forth in Table I with respect to the 15/16 inch dimensional size tool. The sizing of the component parts associated with the embodiment of FIGS. 10-12A is set forth in Table I and is associated with the commercial size product 1⅛ inch. The dimensional relationships are labeled in each of the drawings.

It is to be noted that in the commercial embodiments the prongs are symmetrical in terms of the number of flats and their size and position on each side of the longitudinal axis for each prong. However, this is not a necessary limitation and the size and dimensional configurations of the various reverse taper flats may be distinct with respect to the separate prongs, such as the prongs 110 and 112. In practice, at least two flats or reverse taper surfaces are considered desirable on a prong. The range of the angular relationship of the various component parts may be varied. Table I sets forth a range with respect to the various dimensional features of the wedge shaped head. For example, the planar face 134 may form an angle with surface 117 in the range of about 20°-30°. The range of the angle of planar face 136 with a horizontal axis may be in the range of 10°-20°. The reverse pitch of the various flat surfaces or tapers, such as the surface 118, may be in the range of 3°-8°. The reverse pitch of the various flats may vary from flat to flat and from side to side of the prongs. The depth or height of the transverse surface, such as the surface 128, may be varied. The leading end surface (e.g. 117 in FIG. 6) may be generally coplanar with the multiple reverse taper flat composite surface 118, 120, 122, etc. This is illustrated in FIG. 6.

FIG. 15 illustrates a manner of use of the tool. In FIG. 15 the wedge shaped head 160 is depicted with flats positioned upwardly against a rubber boot. It is preferred that the flats be reversed in orientation and face downwardly against a metal part rather than against a rubber boot. For purposes of illustration, however, FIG. 15 depicts the manner in which the wedge shaped head is positioned between parts that are to be separated and around an element such as a fastener or rod.

Additionally, the described prong construction may be incorporated into a tool wherein the drive or impact handle is integral with the bifurcated prongs or head (see FIG. 16). A head 200 and handle 202 are integrally fabricated or made with the head 200 characterized as heretofore described. Various other changes may be adopted. The embodiments depicted are considered the current best mode of the invention. That is, the placement of reverse taper steps on only a single top or bottom side of the prongs is considered beneficial and a symmetrical array of reverse taper steps is also considered beneficial, though offset steps on the separate prongs may facilitate use of the tool.

Thus, while there have been set forth embodiments of the invention, the invention is to be limited only by the following claims and equivalents.

What is claimed is:

1. In an automotive separating tool for tie rods and ball joint connections, the separating tool including:
a wedge-shape head that has a first end facing in one direction and a second end facing in the other, opposite direction along a longitudinal axis extending from the first end to the second end, said head including a pair of spaced-apart prongs extending from the one end of the head in the one direction, with the tapered portion of the prongs forming a wedge to be forced between the parts to be separated;
and an elongated handle that extends from the second end of the head in the other direction, said handle having a first end and a distal end, said distal end being adapted to be struck in the one direction during the separating of parts by the tool, the shape of the distal end of the handle being one of either a shape where the distal end may be struck by a hammer or a shape where the distal end may be driven by an air hammer, the head including:
a threaded recess formed in the second end of the head; and
a threaded projection formed on the first end of a handle, with the threaded projection being removably threaded into and received within the threaded recess so that the handle and head are connected together during the use of the tool, the improvement comprising:
said prongs each comprising a wedge shape configuration formed by first and second generally divergent main surfaces diverging from one another along the longitudinal axis from the first end toward the second end, said first main surfaces of said first and second prongs generally coplanar, and said second main surface of said first and second prongs generally coplanar, at least one of said first and second main surfaces, at least two separate, adjacent, planar, reverse taper flats, said flats separated by a step defining an edge between the flats generally transverse to the longitudinal axis, said flats defining a generally saw-tooth, side profile of planar surfaces substantially transverse to the longitudinal axis, said edge parallel to the first and second main surfaces.

2. The tool of claim 1 wherein each prong is comprised of a wedge shaped leading end and at least two, adjacent, reverse taper flats on a main surface.

3. The tool of claim 2 wherein the prongs are substantially identical.

4. The tool of claim 2 wherein the leading end on the side of the prong opposite from the flats is comprised of a planar face inclined in the range of about 20°-30° with respect to a horizontal plane in the axial direction.

5. The tool of claim 4 wherein the first planar face is inclined at an angle in the range of about 10°-20° with respect to a horizontal plane.

6. The tool of claim 5 wherein the prongs are substantially identical.

7. The tool of claim 1 wherein the reverse pitch of at least one of the flats is in the range of 3°-8°.

8. The tool of claim 7 wherein the flats have an equal reverse pitch.

9. The improved separating tool of claim 1 wherein the handle and the head may be readily separated by unthreading the connection between the threaded recess and the threaded projection.

10. The improved separating tool of claim 1 wherein the threaded recess is formed within the head and the threaded projection is integrally formed on the first end of handle, with the longitudinal axis of the handle is co-axial with the longitudinal axis of the threaded projection and the threaded recess.

11. In an automotive separating tool for tie rods and ball joint connections, the separating tool including: a wedge-shape head that has a first end facing in one direction and a second end facing in the other, opposite direction, that has first and second tapered spaced-apart prongs extending from the one end of the head in the one direction, with the tapered portion of the prongs creating a wedge to be forced between the parts, the second end of the head in the other direction, said handle having a first end and a distal end, said distal end being adapted to be struck in the one direction end during the separating of the parts, the shape of the distal end of the handle being one of either a shape where the distal end may be struck by a hand held hammer or a shape where the distal end may be driven by an air hammer, said second end of the head and said first end of the handle being integral, the improvement comprising:
said first and second prongs having a longitudinal axis from the front end toward the second end, said prongs including a configuration comprised of first and second generally divergent, main surfaces, diverging apart from each other along the longitudinal axis from the front end toward the second end, said first main surfaces of the prongs being generally coplanar, said second main surfaces of the prongs being generally coplanar, one of said first and second main surfaces of at least one of said prongs including at least two separate, adjacent, planar, reverse taper flats, said flats separated by a step defining an edge between the flats generally transverse to the longitudinal axis, said flats defining a generally saw-tooth, side profile of planar surfaces substantially transverse to the longitudinal axis of the prong, said edge parallel to the first and second main surfaces.

12. The tool of claim 11 wherein the second surfaces each include substantially identical reverse taper flats.

13. The tool of claim 12 wherein each prong includes a leading end formed by first and second diverging generally flat planar leading end surfaces, said first leading end surfaces being generally coplanar and said second leading end surfaces being coplanar, said first and second leading end surfaces diverging from each other at an acute angle of about 20° to 30° and said main first and second surfaces diverging at an acute angle of about 10° to 20°.

14. The tool of claim 13 wherein each prong includes substantially identical reverse taper flats on the second main surface and the second main surface and second leading edge surface are substantially coplanar.
